(19) United States
(12) Patent Application Publication
(10) Pub. No.: US 2026/0257590 A1
(43) Pub. Date: Sep. 3, 2026

(54) LONGITUDINAL ADJUSTMENT DEVICE AND VEHICLE SEAT

(71) Applicant: Adient US LLC, Plymouth, MI (US)

(72) Inventors: Erik SPRENGER, Wermelskirchen (DE); Maros ROVNY, Adamovské Kochanovce (SK)

(73) Assignee: Adient US LLC, Plymouth, MI (US)

(21) Appl. No.: 18/872,030

(22) PCT Filed: Jun. 7, 2023
(86) PCT No.: PCT/IB2023/055867

§ 371 Date: Dec. 5, 2024

(30) Foreign Application Priority Data
Jun. 7, 2022 (DE) 10 2022 205 765.1
Aug. 26, 2022 (DE) 10 2022 208 888.3

(51) Int. Cl. B60N 2/07

(52) U.S. Cl. CPC B60N 2/0722; B60N 2205/20

(57) ABSTRACT

A longitudinal adjustment device for a vehicle seat may have at least one track arrangement with a first track element and a second track element, which are movable relative to one another. The device may have at least one or more bearing points, each having at least two rollers, located between the first track element and the second track element. One of the rollers is rotatably mounted without backlash and the other roller is rotatably mounted with backlash and so as to be spring-biased. The roller mounted without backlash is rotatably mounted on an upper rotary bearing, as seen in the height direction, so as to be positionally fixed and the flexibly mounted roller is flexibly rotatably mounted on a lower rotary bearing. A vehicle seat having the longitudinal adjustment device is also provided.

The invention relates to a longitudinal adjustment device, in particular for a vehicle seat, having at least one pair of tracks and a vehicle seat.

### PRIOR ART

A seat longitudinal adjustment device generally comprises two pairs of tracks which are arranged spaced apart from one another and which in each case are constructed from two tracks, an upper track assigned to the seat and a lower track assigned to the floor of a vehicle. The seat longitudinal adjustment device also comprises at least one spring-loaded, movable, plate-shaped locking part which is held on the upper track and in a locked position blocks a movement of the upper track in the lower track. The lower track can have through-holes, while the upper track is provided with openings and the locking part on its two opposing longitudinal sides bears projections which in the locked position are movable by a spring both into the openings and into the through-holes. Such a seat longitudinal adjustment device is disclosed, for example, in the European patent EP 1 227 950 B1.

Pairs of tracks having an upper track and a lower track are known from the prior art, wherein rollers are arranged therebetween in order to roll the upper track on the lower track or vice versa. Conventionally, the rollers are rotatably mounted via bearing bolts on the upper track or lower track.

The object of the present invention is to specify a longitudinal adjustment device which is improved relative to the prior art and which is of simple construction and comprises an improved bearing.

### Solution

A longitudinal adjustment device according to the invention comprises at least one pair of tracks with a first track element which is configured, in particular, as an upper track and a second track element which is configured, in particular, as a lower track and which are movable relative to one another, wherein at least two or more bearing points are provided between the first track element and the second track element, wherein at least two rollers are provided at the respective bearing point, wherein one of the rollers is rotatably mounted without backlash at the respective bearing point and the other roller is flexibly rotatably mounted, in particular with backlash and so as to be spring-biased.

For example, the roller mounted without backlash is rotatably mounted on an upper rotary bearing, as seen in the height direction or perpendicularly to the longitudinal adjustment direction, so as to be positionally fixed. The flexibly mounted roller is flexibly rotatably mounted, for example, on a lower rotary bearing.

For example, the rollers are rotatably mounted inside one of the track elements, in particular inside the movable track element, for example inside an upper track.

In particular, the rollers of the respective bearing point are configured such that a self-centering roller bearing is formed. For example, at the respective bearing point in the one track element, in particular in the movable track element, the rollers form the self-centering roller bearing between opposing running surfaces on the other track element, in particular the positionally fixed track element. In particular, such a roller arrangement with an upper positionally fixed roller and a lower flexible roller permits a self-centering function between the upper positionally fixed roller and the lower flexible roller. The lower flexible roller can also have a self-centering function and/or a tolerance compensating function and can be biased in the height direction with or without stroke limitation.

For example, the first track element, in particular the upper track, can be configured as a movable track element, as a movable slide or a sliding track. The second track element, in particular the lower track, can be configured as a positionally fixed track element, for example, as a fixed floor track or a fixed track. The movable upper track is slidably mounted relative to the lower track, for example, by means of the rollers at the respective bearing point. The upper track can also be configured to bear a seat. The lower track can be fastened, for example, to a vehicle floor or a vehicle body.

The upper track comprises, for example, two rotary bearings for the rollers at the respective bearing point. The two rotary bearings of each bearing point are configured in each case as a roller bearing. The two rotary bearings with their rollers form the self-centering roller bearing of each bearing point. The lower track comprises, for example, two running surfaces for the two rotary bearings for each bearing point.

The respective bearing point comprises, for example, the roller without backlash as a first roller which is rotatably mounted without backlash, in particular radially, on a first rotary bearing of the upper track. In other words: the first rotary bearing of each bearing point is configured as a positionally fixed rotary bearing or fixed bearing. The first roller or roller without backlash rolls on a first running surface of the lower track.

The respective bearing point also comprises, for example, the flexible roller as a second roller which is rotatably mounted on a second rotary bearing of the upper track with, in particular, vertical or radial backlash and so as to be spring-biased. In other words: the second rotary bearing of each bearing point is configured as a movable rotary bearing. The second roller or flexible roller rolls on a second running surface of the lower track. For example, a spring element can be provided for the biased bearing of the second roller or flexible roller. The spring element is configured, for example, as a flat spiral spring or a flat spring. The spring element can be biased, for example, in a curved manner in the assembled state and coupled to the second roller on flexible roller, in particular the bearing bolts thereof. In particular, the spring element is arranged with one end on a side wall of the upper track and with an opposing end on a bottom region of the upper track. A central spring portion acts on the flexible roller, in particular on the bearing bolt of this flexible roller.

The spring element can be designed, for example, to spring-bias the flexible roller in the direction of a lower running surface of one of the track elements, in particular the positionally fixed track element, with a stroke limitation or without stroke limitation. In particular, the spring element can be designed such that the spring force thereof acts perpendicularly to the longitudinal adjustment direction of one of the track elements, in particular the movable track element. The spring element can also be designed such that the flexible roller is rotatably positionable in a self-centering manner, in particular is rotatably positionable in a self-centering manner on the lower running surface.

The advantages achieved by the invention are, in particular, that a tolerance compensation function is made possible, in particular radially and/or vertically, due to the combination according to the invention of a roller mounted without backlash (also called a “fixed” roller) and a roller mounted with backlash (also called a “flexible” roller) at one or more bearing points of the longitudinal adjustment device, and in particular by the configuration as a self-centering roller bearing.

### FIGURES AND EMBODIMENTS OF THE INVENTION

The invention is explained in more detail hereinafter with reference to the exemplary embodiments shown in the figures. However, the invention is not limited to these exemplary embodiments. In the figures:

FIG. 1 shows in a schematic view a vehicle seat with a longitudinal adjustment device according to the prior art,

FIG. 2 shows schematically in a perspective and partially sectional view an exemplary embodiment of an upper track of a longitudinal adjustment device according to the invention,

FIG. 3 shows schematically in a perspective view from below the exemplary embodiment of the upper track according to FIG. 2,

FIG. 4 shows schematically in a sectional view an enlarged detail of a bearing point of the upper track according to FIG. 2,

FIG. 5 shows schematically in a perspective view from above the exemplary embodiment of the upper track according to FIG. 2,

FIG. 6 shows schematically a sectional view in the region of a first roller of a bearing point of a longitudinal adjustment device according to the invention,

FIG. 7 shows schematically a sectional view in the region of the first roller of the bearing point according to FIG. 6 without the second roller,

FIG. 8 shows schematically a sectional view in the region of the bearing point according to FIG. 6 without the lower track,

FIG. 9 shows schematically a sectional view in the region of the first roller according to FIG. 7 without the lower track,

FIG. 10 shows schematically a perspective view of an exemplary embodiment of a first roller,

FIG. 11 shows schematically a sectional view in the region of a second roller of a bearing point of a longitudinal adjustment device according to the invention,

FIG. 12 shows schematically a sectional view in the region of the second roller of the bearing point according to FIG. 11 without the first roller,

FIG. 13 shows schematically a sectional view in the region of the bearing point according to FIG. 11 without the first roller and without the lower track,

FIG. 14 shows schematically a sectional view in the region of the second roller according to FIG. 13 without the lower track, and

FIG. 15 shows schematically a perspective view of an exemplary embodiment of a second roller.

Parts which correspond to one another are provided with the same reference signs in all of the figures.

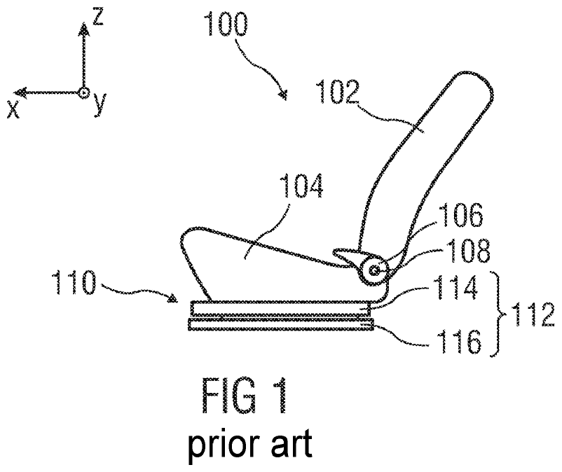

A vehicle seat 100, shown schematically in FIG. 1, is described hereinafter by using three spatial directions running perpendicularly to one another. A longitudinal direction x runs substantially horizontally in a vehicle seat 100 installed in the vehicle and preferably parallel to a vehicle longitudinal direction, which corresponds to the usual direction of travel of the vehicle. A transverse direction y running perpendicularly to the longitudinal direction x is also horizontally oriented in the vehicle and runs parallel to a vehicle transverse direction. A height direction z runs perpendicularly to the longitudinal direction x and perpendicularly to the transverse direction y. In a vehicle seat 100 installed in the vehicle, the height direction z preferably runs parallel to a vehicle height axis.

The positional information and directional information used, such as for example front, rear, top and bottom, refer to a viewing direction of an occupant seated in the vehicle seat 100 in the normal seating position, wherein the vehicle seat 100 installed in the vehicle is oriented in a suitable position of use for passenger conveyance, with an upright backrest 102 and in the direction of travel as is usual. The vehicle seat 100, however, can also be fitted or moved in a different orientation, for example transversely to the direction of travel.

The backrest 102 can be pivotably arranged on a seat part 104 of the vehicle seat 100. To this end, the vehicle seat 100 can comprise a fitting 106, in particular an adjustment fitting, rotary fitting, latching fitting or wobble fitting.

The positional information and directional information used, such as for example radially, axially and in the peripheral direction, refer to an axis of rotation 108 of the fitting 106. Radially means perpendicular to the axis of rotation 108. Axially means in the direction of or parallel to the axis of rotation 108.

The vehicle seat 100 can comprise a longitudinal adjustment device 110. The longitudinal adjustment device 110 comprises, for example, a track arrangement 112 with a first track element 114 and a second track element 116. The first track element 114 is adjustable in the longitudinal direction x relative to the second track element 116. The first track element 114 is fastened to the seat part 104. The second track element 116 is fastened to a structural element of a vehicle, for example a vehicle floor.

For improved clarity, the first track element 114 is denoted in the following description as the upper track 114. This upper track 114 (also called the sliding track or slide) is assigned to the vehicle seat 100 and designed to bear this vehicle seat 100. The second track element 116 is denoted hereinafter as the lower track 116. The lower track 116 is connected fixedly and, for example, to the floor of a vehicle.

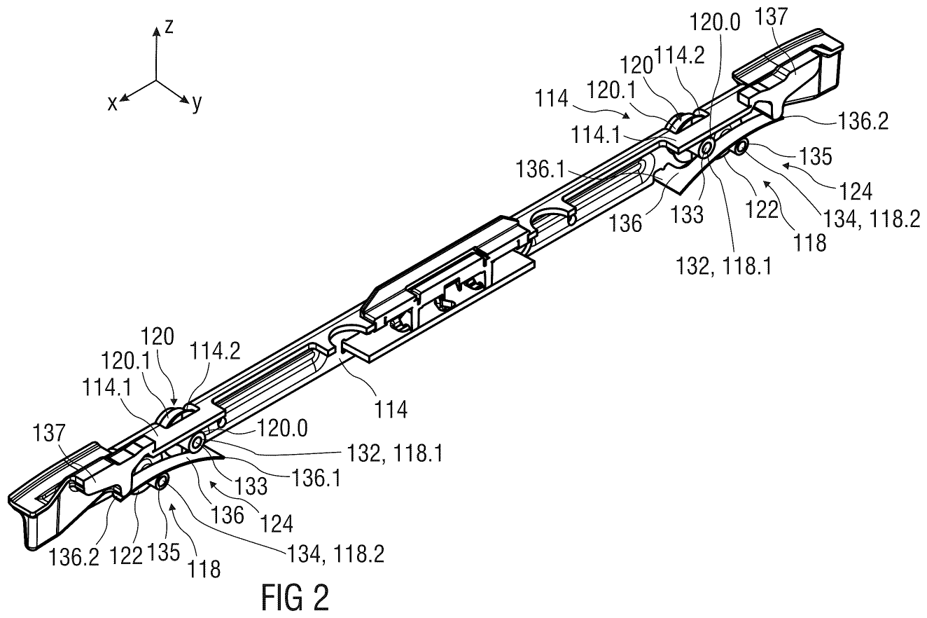

FIGS. 2 to 15 show exemplary embodiments and developments of the longitudinal adjustment device 110 hereinafter in detail.

FIG. 2 shows schematically in a perspective and partially sectional view an exemplary embodiment of an upper track 114 of the longitudinal adjustment device 110 (shown in FIG. 1) which is described hereinafter in detail.

The upper track 114 of the longitudinal adjustment device 110 comprises at least one or more bearing points 118 for the movable bearing of the upper track 114 relative to the lower track 116. In the exemplary embodiment shown, two bearing points 118 are provided. However, more bearing points 118 or only one bearing point 118 can be provided (not shown in more detail).

The respective bearing point 118 comprises at least two rollers 120 and 122.

A first roller 120 (also called the roller mounted without backlash or positionally fixed roller) of the respective bearing point 118 is rotatably mounted without backlash. A second roller 122 (also called the flexible roller or tolerance-compensating roller) of the respective bearing point 118 is rotatably mounted with backlash and so as to be spring-biased.

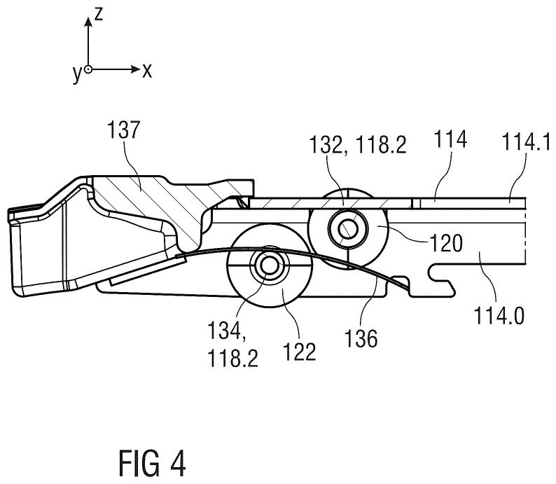

The first roller 120, in particular mounted without backlash, as seen in the height direction z, is rotatably mounted in a positionally fixed manner on an upper rotary bearing 118.1. The second, in particular flexibly mounted, roller 122 is flexibly rotatably mounted on a lower rotary bearing 118.2, as shown in FIGS. 2 and 4.

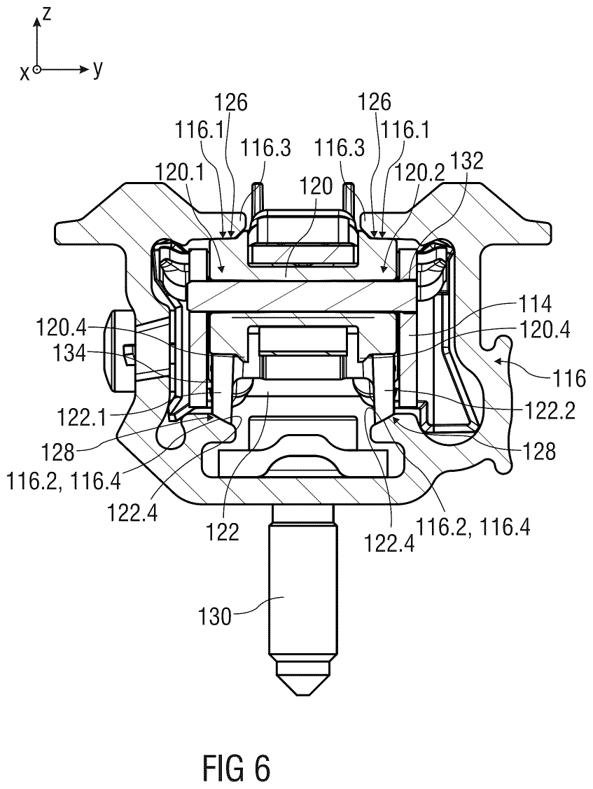

In particular, the rollers 120, 122 of the respective bearing point 118 are configured such that a self-centering roller bearing 124 is formed. For example, the rollers 120, 122 of the respective bearing point 118 form the self-centering roller bearing 124 between opposing running surfaces 126, 128 (shown in FIG. 6) of the longitudinal adjustment device 110.

In other words: the combination of a first roller 120 mounted without backlash (also called the “fixed” roller or positionally fixed roller) and a second roller 122 mounted with backlash (also called the “flexible” roller or “movable” roller) at the respective bearing point 118 forms the self-centering roller bearing 124. The self-centering roller bearing 124 of each bearing point 118 permits a simple tolerance-compensating function in the radial direction and/or vertical direction.

For example, the upper track 114 can be configured as a movable slide or a sliding track. The lower track 116 (shown in FIGS. 1 and 6 and 7) can be configured, for example, as a fixed floor track or a fixed track.

The movable upper track 114, for example, is slidably mounted by means of rollers 120, 122 at the respective bearing point 118 relative to the lower track 116. The upper track 114 can also be configured to bear the vehicle seat 100.

The fixed lower track 116 can be fastened, for example, by means of a fastening element 130 (shown in FIG. 6), in particular a bolt, a rivet, or a screw, to a vehicle floor or a vehicle body.

The upper track 114 can comprise, for example, two rotary bearings 132, 134 at the respective bearing point 118: a first rotary bearing 132 for the first roller 120 and a second rotary bearing 134 for the second roller 122. The first rotary bearing 132 has a first axis of rotation 133. The second rotary bearing 134 has a second axis of rotation 135.

The first roller 120 is rotatably mounted on the first rotary bearing 132, in particular on the upper rotary bearing 118.1, of the upper track 114 without backlash, in particular radially without backlash. The first roller 120 thus is a rotatable and fixed or stationary element regarding its bearing position. The first rotary bearing 132 is configured as a positionally fixed bearing or fixed bearing.

The second roller 122 is rotatably mounted on the second rotary bearing: 134, in particular the lower rotary bearing 118.2, of the upper track 114 with, in particular, vertical and/or radial backlash and so as to be spring-biased. The second roller 122 is thus a rotatable element and flexible or movable element relative to its bearing position. The second rotary bearing 134 is configured as a movable bearing or flexible bearing.

By such a combination of the first roller 120 mounted without backlash (also called the “fixed” roller) and the second roller 122 mounted with backlash (also called the “flexible” roller), the self-centering roller bearing 124 is formed at the respective bearing point 118 of the longitudinal adjustment device 110.

The first roller 120 of each bearing point 118 can also or optionally have an integrated function of self-centering in the upper track 114 and be mounted, for example, with backlash, in particular a radial and/or vertical backlash, in the upper track 114.

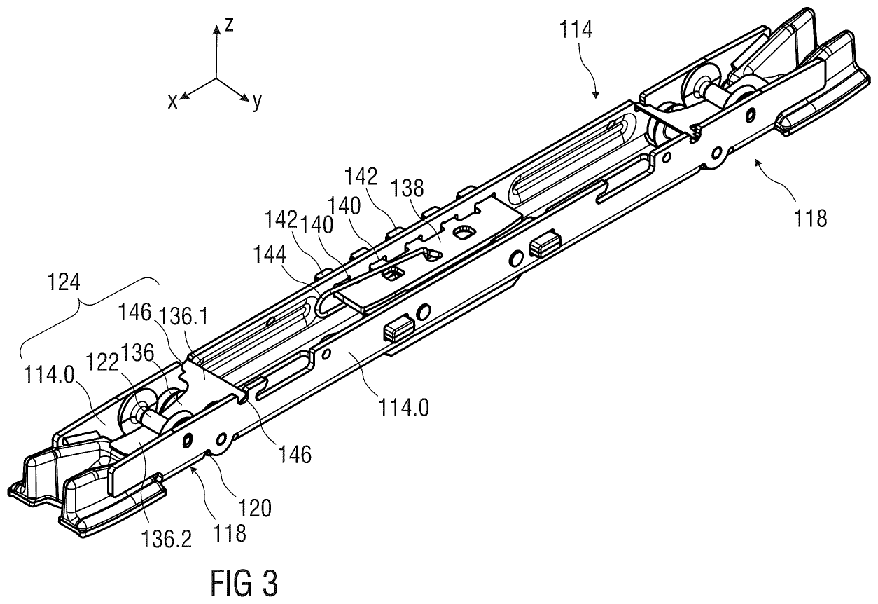

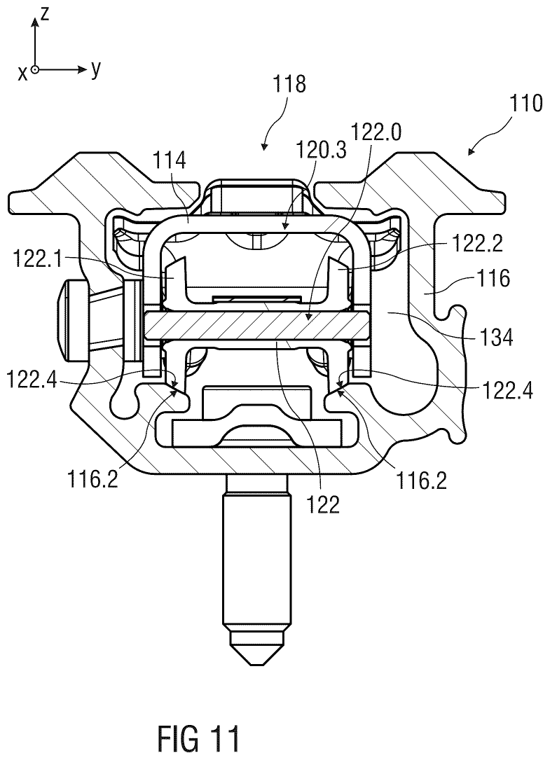

The first roller 120 (also called the fixed roller) is rotatably held, for example, by a bearing bolt 120.0 or pin and a bearing holder 120.3 (shown in FIG. 11) without backlash in a bearing position in the upper track 114. The first roller 120 is rotatably arranged substantially within a U-shaped profile of the upper track 114. In a transition region between a side wall 114.0 (shown in FIG. 3) and a bottom region 114.1, the upper track 114 can have in each case a recess 114.2 through which the first roller 120, in particular a first running wheel 120.1 of this first roller 120, at least partially protrudes, projecting over the bottom region 114.1.

The second roller 122 (also called a flex roller) can have the above-described integrated function of self-centering in the upper track 114 by means of the bearing which is provided with backlash and spring-biased.

Alternatively, the second roller 122 can be rotatably mounted without backlash in the upper track 114 and the first roller 120 can be rotatably mounted with backlash in the upper track 114 (not shown).

In a further alternative embodiment, both rollers 120 and 122 can be rotatably mounted with backlash in the upper track 114 (not shown).

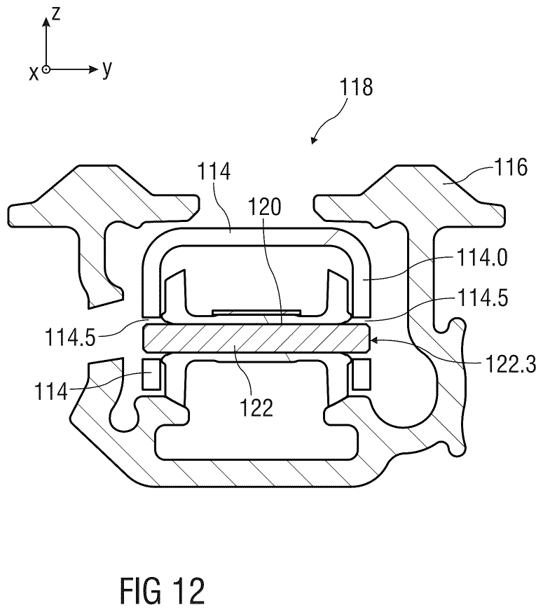

The second roller 122 is rotatably held and so as to be spring-loaded in the height direction z, for example, by a bearing bolt 122.0 or pin and a bearing holder 122.3 (shown in FIG. 12) with, in particular, a radial backlash and/or a vertical backlash, in particular in the height direction z, in a bearing position in the upper track 114.

For example a spring element 136, in particular a leaf spring or a bending spring, is provided for the spring-biased or spring-loaded bearing of the second roller 122. The spring element 136 can have, for example, a predetermined stroke, in particular a vertical stroke, with a stroke limitation or without stroke limitation. The spring element 136 is arranged, for example, in the height direction z with or without a stroke limitation such that the spring force thereof acts or can be applied directly on the second roller 122 or indirectly on the bearing bolt 122.0 thereof.

The spring element 136 can be designed, for example, to spring-bias the second roller 122 in the direction of a lower running surface (=second running surface 128, shown in FIG. 6) of the lower track 116 with a stroke limitation or without stroke limitation. In particular, the spring element 136 can be designed such that the spring force thereof acts perpendicularly to the longitudinal adjustment direction in the longitudinal direction x of the upper track 114. The spring element 136 can also be designed such that the second roller 122 (=flexible roller) is rotatably positionable in a self-centering manner on the lower running surface 128 (=second running surface 116.2) of the lower track 116.

The spring element 136 is configured, for example, as a flat spring or a spring band. The spring element 136 is fixed, for example, with one end 136.1 on the side wall 114.0 (shown in FIG. 3) of the upper track 114 and with an opposing end 136.2 on the bottom region 114.1 of the upper track 114 or a latch lock 137 arranged on a front end of the upper track 114, and applies a predetermined spring force onto the second roller 122 located between these two ends 136.1 and 136.2. In the assembled state of the spring element 136 and second roller 122, this spring element 136 is biased, for example, in a curved manner. In particular, the spring element 136 pushes with its inside curve against the second bearing 134 of the second roller 122, in particular against the second bearing bolt 122.0 of the second roller 122. As a result, the second roller 122 is spring-biased and mounted in a tolerance-compensating manner in the height direction z, in particular relative to the lower track 116.

The latch lock 137 serves, in particular, for receiving a rotary latch or a locking hook of the vehicle seat 100 in a locked manner and thus for fastening the vehicle seat 100 to the upper track 114.

FIG. 3 shows schematically in a perspective view from below the exemplary embodiment of the upper track 114 according to FIG. 2.

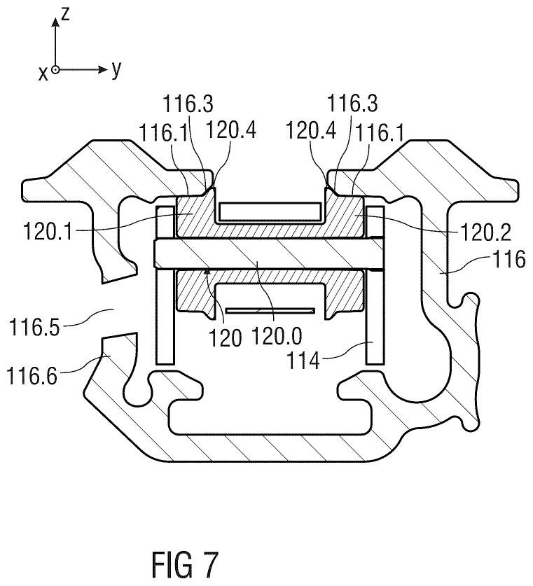

The longitudinal adjustment device 110 can also have at least one spring-loaded, movable, plate-shaped locking part 138 which is held on the upper track 114. The locking part 138, for example a locking plate or a locking lever, blocks a movement of the upper track 114 in the lower track 116 (shown in FIG. 1) in a locked position. To this end, the lower track 116 can have through-holes 116.5 (shown in FIG. 7), while the upper track 114 is provided with openings 140.

The locking part 138 can have, on one or both opposing longitudinal sides, projections 142 which in the locked position are movable by a spring 144 both into the openings 140 and into the through-holes 116.5 (shown in FIG. 7) of the lower track 116 (shown in FIG. 1).

The longitudinal adjustment device 110 has two bearing points 118 which are provided, for example, in end regions of the upper track 114.

The spring element 136 is fixed with the one end 136.1 in the spring receivers 146 in the side walls 114.0 of the upper track 114. The spring element 136 is fixed with the opposing end 136.2 to the latch lock 137. The second roller 122 is spring-biased centrally between the ends 136.1 and 136.2 and movably mounted with or without a stroke in the height direction z, in particular relative to the lower track 116.

The two bearing points 118, which are provided in the end regions of the upper track 114, comprise in each case in a similar manner the two rollers 120 and 122 which in turn form the self-centering roller bearing 124.

FIG. 4 shows schematically in a sectional view an enlarged detail of one of the bearing points 118 of the upper track 114 according to FIG. 2.

The first roller 120 is rotatably mounted on the first rotary bearing 132 of the upper track 114 without backlash, in particular without radial backlash. The second roller 122 is rotatably mounted on the second rotary bearing 134 of the upper track 114 with, in particular, a vertical and/or radial backlash and so as to be spring-biased by means of the spring element 136, in particular relative to the track arrangement 112, in particular relative to the lower track 116.

The spring element 136 as described above is fixed to the latch lock 137 and the side wall 114.0 and applies a spring force onto the second roller 122 arranged therebetween.

The first roller 120 protrudes upwardly beyond the bottom region 114.1 in the height direction z. The second roller 122 protrudes downwardly beyond an open end of the side wall 114.0 in the height direction z.

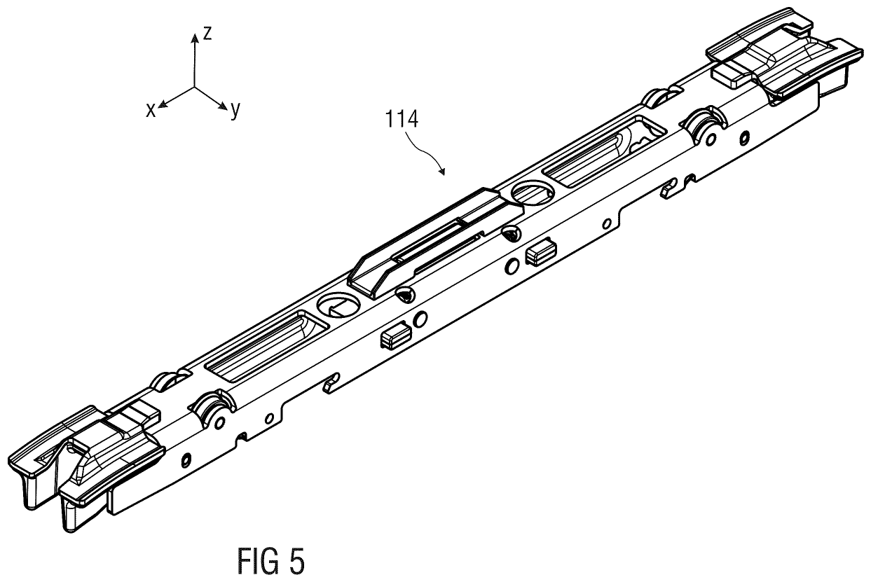

FIG. 5 shows schematically in a perspective view from above the exemplary embodiment of the upper track 114 according to FIGS. 2 to 4.

FIG. 6 shows schematically a sectional view in the region of the first roller 120 of one of the bearing points 118 of the longitudinal adjustment device 110 according to the invention.

The upper track 114 and the lower track 116 are configured in each case as profiles, in particular U-shaped profiles.

The lower track 116 comprises, for example, two running surfaces 116.1, 116.2, at least one first running surface 116.1 for the first roller 120 and at least one second running surface 116.2 for the second roller 122.

The first roller 120 is rotatably mounted on the first rotary bearing 132 of the upper track 114 without backlash, in particular without radial backlash, and rolls on the first running surface 116.1 of the lower track 116.

The second roller 122 is rotatably mounted on the second rotary bearing 134 of the upper track 114, in particular with a vertical and/or radial backlash and so as to be spring-biased, and rolls on the second running surface 116.2 of the lower track 116.

The self-centering roller bearing 124 is formed by such a combination of the first roller 120 mounted without backlash (also called the “fixed” roller) and the second roller 122 mounted with backlash (also called the “flexible” roller) at the respective bearing point 118 of the longitudinal adjustment device 110. The self-centering roller bearing 124 is configured, in particular, as a self-centering 4-point bearing. The two rollers 120, 122 have in each case two running wheels 120.1, 120.2 and 122.1, 122.2 which in each case form a point bearing and together form the 4-point bearing.

The self-centering roller bearing 124 of the respective bearing point 118 is understood to mean, in particular, a tolerance-compensating and thus self-centering bearing of the rollers 120 and 122 between the lower track 116 and the upper track 114. Such a self-centering roller bearing 124 permits, for example, a tolerance-compensating function, in particular in the radial direction and/or vertical direction (in the height direction z) between the lower track 116 and the upper track 114.

For the self-centering bearing of the first roller 120 between the upper track 114 and the lower track 116, the first roller 120, in particular the running wheels 120.1, 120.2 thereof, has a peripheral collar 120.4 which is configured corresponding to a bevel 116.3 of the first running surfaces 116.1.

For the self-centering bearing of the second roller 122 between the upper track 114 and the lower track 116, the second roller 122, in particular the running wheels 122.1, 122.2 thereof, has an incline 122.4 which is configured corresponding to an incline 116.4 of the respective second running surface 116.2.

FIG. 7 shows schematically a sectional view in the region of the first roller 120 of the bearing point 118 according to FIG. 6 without the second roller 122.

FIG. 7 shows the self-centering bearing of the first roller 120 between the upper track 114 and the lower track 116 by means of the peripheral collar 120.4 of the running wheels 120.1 and 120.2 and the corresponding bevel 116.3 of the first running surfaces 116.1. The respective peripheral collar 120.4 is configured corresponding to the respective bevel 116.3 of the first running surface 116.1. The lower track 116 has for each running wheel 120.1 and 120.2 an associated running surface 116.1 with in each case a bevel 116.3.

The first roller 120 is rotatably mounted without backlash by means of the bearing bolt 120.0 in the upper track 114.

At least one side wall 116.6 of the lower track 116 has the through-holes 116.5 for the locking part 138 (shown in FIG. 3).

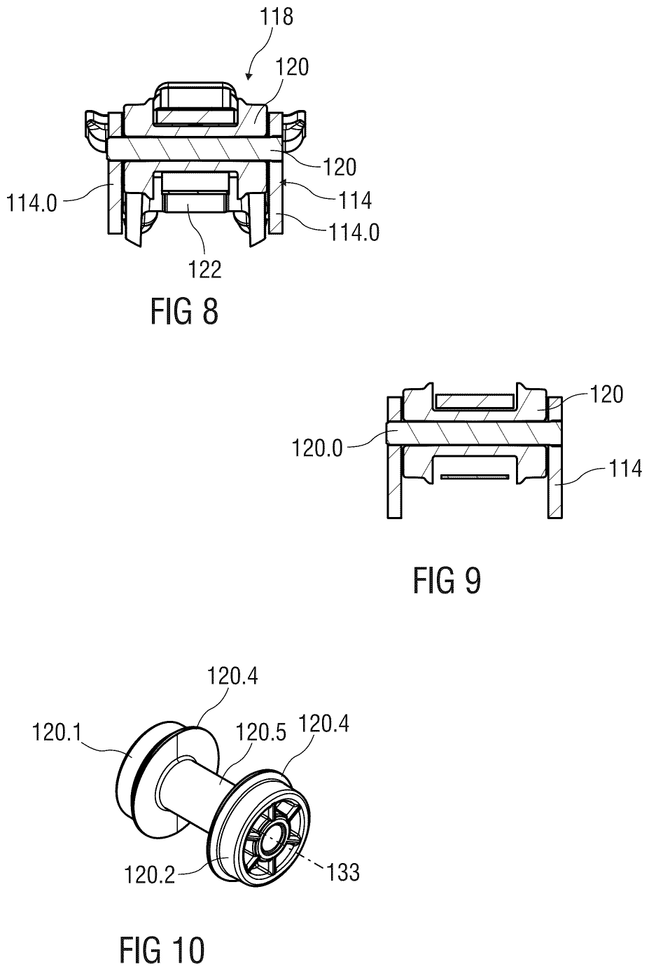

FIG. 8 shows schematically a sectional view in the region of the bearing point 118 with the first roller 120 rotatably mounted without backlash between the upper track 114 and the lower track 116 by means of the bearing bolt 120.0, and the second roller 122 mounted with backlash, according to FIGS. 6 and 7 and without the lower track 116. The bearing bolt 120.0 is mounted without backlash in the side walls 114.0 of the upper track 114.

FIG. 9 shows schematically a sectional view in the region of the first roller 120 rotatably mounted without backlash by means of the bearing bolt 120.0 on the upper track 114, according to FIG. 7 or 8 without the lower track 116.

FIG. 10 shows schematically a perspective view of an exemplary embodiment of a first roller 120. The first roller 120 is configured as a cylindrical roller with the two running wheels 120.1 and 120.2. The first roller 120 can be configured in one piece (as shown). The two running wheels 120.1, 120.2 are connected together via an integrated web 120.5. The web 120.5 extends along the first axis of rotation 133.

The respective running wheel 120.1, 120.2 has, for example, the peripheral collar 120.4 for self-centering the first roller 120 relative to the upper track 114.

FIG. 11 shows schematically a sectional view in the region of the second roller 122 of one of the bearing points 118 of the longitudinal adjustment device 110 according to the invention.

The second roller 122 is rotatably mounted and so as to be spring-biased on the second rotary bearing 134 of the upper track 114 with, in particular, vertical and/or radial backlash, and rolls on the second running surfaces 116.2 of the lower track 116.

For the self-centering bearing of the second roller 122 between the upper track 114 and the lower track 116, the second roller 122, in particular the running wheels 122.1, 122.2 thereof, has in each case an incline 122.4 which is configured corresponding to the incline 116.4 of the second running surfaces 116.2.

FIG. 12 shows schematically a sectional view in the region of the second roller 122 of the bearing point 118 mounted with backlash in the upper track 114 according to FIG. 11 without the first roller 120.

The second roller 122 is rotatably mounted and with backlash by means of the bearing bolt 122.0 in the upper track 114. To this end, the side walls 114.0 have, in particular, through-openings 114.5 as a bearing holder 122.3. The through-openings 114.5 can be configured, for example, as a slot or a circular hole. The through-openings 114.5 have, for example, greater dimensions than the outer peripheral dimensions of the bearing bolt 122.0.

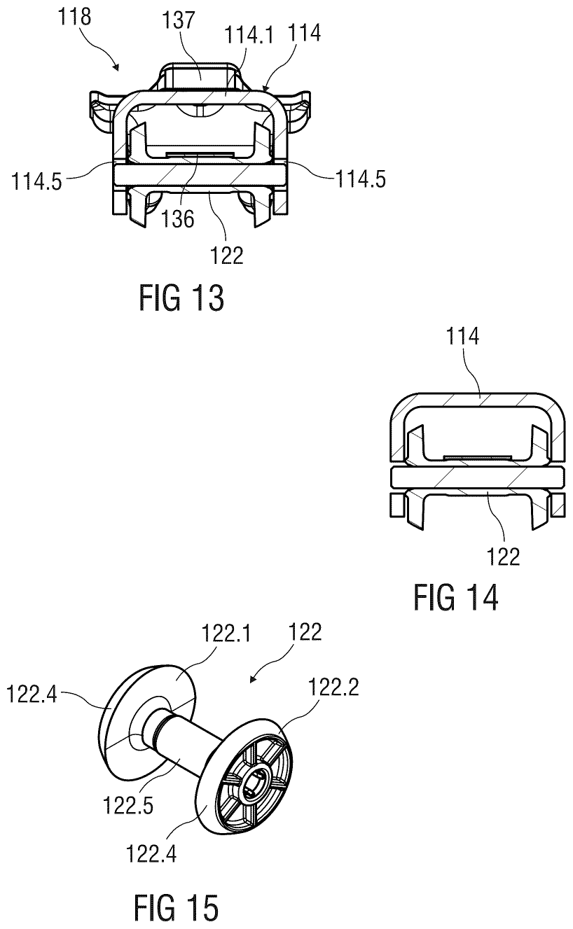

FIG. 13 shows schematically a sectional view in the region of the bearing point 118, only with the second roller 122 according to FIGS. 11 and 12 and without the first roller 120 and without the lower track 116 (shown in FIG. 2). The second roller 122 is rotatably mounted with radial backlash and/or vertical backlash in the through-openings 114.5.

The spring element 136 acts directly on the second roller 122.

The latch lock 137 is arranged on a front end of the upper track 114 on the bottom region 114.1 of the upper track 114, in particular connected thereto in a force-fitting manner, form-fitting manner and/or by a material bond.

FIG. 14 shows schematically a sectional view in the region of the second roller 122 mounted with backlash in the upper track 114 according to FIG. 13 without the lower track 116 and without the locking part 138 (shown in FIG. 3).

FIG. 15 shows schematically a perspective view of an exemplary embodiment of the second roller 122.

The second roller 122 is configured as a cylindrical roller with the two running wheels 122.1 and 122.2. The second roller 122 can be configured in one piece (as shown). The two running wheels 122.1, 122.2 are connected together via an integrated web 122.5. The web 122.5 extends along the second axis of rotation 135.

The respective running wheel 122.1, 122.2 has, for example, an incline 122.4 for the self-centering of the second roller 122 relative to the lower track 116 (shown in FIGS. 6, 11 and 12).

The features disclosed in the above description and the figures can be of importance both individually and in combination for implementing the invention in its various embodiments, provided they remain within the protected scope of the invention.

### LIST OF REFERENCE SIGNS

100 Vehicle seat
102 Backrest
104 Seat part
106 Fitting
108 Axis of rotation
110 Longitudinal adjustment device
112 Track arrangement
114 First track element, upper track
114.0 Side wall
114.1 Bottom region
114.2 Recess
114.5 Through-opening
116 Second track element, lower track
116.1 First running surface
116.2 Second running surface
116.3 Bevel
116.4 Incline
116.5 Through-hole
116.6 Side wall
118 Bearing point
118.1 Upper rotary bearing
118.2 Lower rotary bearing
120 Roller, first roller/roller mounted without backlash
120.0 Bearing bolt
120.1 First running wheel
120.2 Second running wheel
120.3 Bearing holder
120.5 Web
122 Roller, second/flexible roller
122.0 Bearing bolt
122.1 First running wheel
122.2 Second running wheel
122.3 Bearing holder
122.4 Incline
122.5 Web
124 Self-centering roller bearing
126 Running surface, first running surface
128 Running surface, second running surface
130 Fastening element
132 First rotary bearing
133 First axis of rotation
134 Second rotary bearing
135 Second axis of rotation
136 Spring element
136.1 End
136.2 Opposing end
137 Latch lock
138 Locking part
140 Opening
142 Projection
144 Spring
146 Spring receiver
X Longitudinal direction
y Transverse direction
Z Height direction

1-15. (canceled)

16. A longitudinal adjustment device for a vehicle seat,
wherein the longitudinal adjustment device comprises at least one track arrangement with a first track element and a second track element which are movable relative to one another, and
wherein at least two or more bearing points, each having at least two rollers, are arranged between the first track element and the second track element,
wherein one of the rollers is rotatably mounted without backlash at the respective bearing point and the other roller is flexibly rotatably mounted, and
wherein the roller mounted without backlash is rotatably mounted on an upper rotary bearing, as seen in the height direction, so as to be positionally fixed and the flexibly mounted roller is flexibly rotatably mounted on a lower rotary bearing.

17. The longitudinal adjustment device as claimed in claim 16, wherein the rollers are rotatably mounted inside one of the track elements.

18. The longitudinal adjustment device as clamed in claim 16, wherein the rollers of the respective bearing point are configured and arranged such that a self-centering roller bearing is formed.

19. The longitudinal adjustment device as claimed in claim 18, wherein at the respective bearing point in the one track element, the two rollers form the self-centering roller bearing between opposing running surfaces on the other track element.

20. The longitudinal adjustment device as claimed in claim 16, wherein the respective bearing point comprises the roller without backlash which is rotatably mounted on a first rotary bearing of the first track element and rolls on a first running surface of the second track element.

21. The longitudinal adjustment device as claimed in claim 20, wherein the first rotary bearing is configured as a positionally fixed bearing.

22. The longitudinal adjustment device as claimed in claim 16, wherein the respective bearing point comprises the flexible roller which is rotatably mounted on a second rotary bearing of the first track element and rolls on a second running surface of the second track element.

23. The longitudinal adjustment device as claimed in claim 22, wherein the second rotary bearing is configured as a movable bearing.

24. The longitudinal adjustment device as claimed in claim 16, wherein the flexible roller is mounted so as to be spring-biased by means of at least one spring element.

25. The longitudinal adjustment device as claimed in claim 24, wherein the at least one spring element is configured as a leaf spring or bending spring.

26. The longitudinal adjustment device as claimed in claim 24, wherein the at least one spring element is coupled to a bearing bolt of the flexible roller.

27. The longitudinal adjustment device as claimed in claim 24, wherein the spring element is designed to spring-bias the flexible roller in the direction of a lower running surface of one of the track elements with a stroke limitation or without stroke limitation.

28. The longitudinal adjustment device as claimed in claim 24, wherein the spring element is designed such that the spring force thereof acts perpendicularly to the longitudinal adjustment direction of one of the track elements.

29. The longitudinal adjustment device as claimed in claim 24, wherein the spring element is designed such that the flexible roller is rotatably positionable in a self-centering manner.

30. A vehicle seat, comprising a longitudinal adjustment device as claimed in claim 16.
